(19) United States
(12) Patent Application Publication
(10) Pub. No.: US 2025/0309707 A1
(43) Pub. Date: Oct. 2, 2025

(54) Axial Flux Electric Machine Stator Frame

(71) Applicant: Conifer Systems, Inc., Middletown, DE (US)

(72) Inventors: Nicholas Peter Deick, Newark, CA (US); Yateendra B. Deshpande, Sunnyvale, CA (US)

(21) Appl. No.: 19/097,819

(22) Filed: Apr. 1, 2025

Related U.S. Application Data
(60) Provisional application No. 63/572,910, filed on Apr. 2, 2024.

(51) Int. Cl. H02K 1/16; H02K 1/02; H02K 1/18; H02K 1/20; H02K 3/34

(52) U.S. Cl. CPC H02K 1/165; H02K 1/02; H02K 1/182; H02K 1/20; H02K 3/345

(57) ABSTRACT

Systems and methods related to axial flux electric machine stator frames are disclosed herein. For example, a stator for an axial electric machine may comprise a stator frame with an inner ring, an outer ring, and a set of spokes connecting the inner ring to the outer ring. The stator may also comprise a set of pockets, formed by the set of spokes, and a set of pole pieces occupying the set of pockets. The stator frame may be formed of a diamagnetic metal with a tensile strength greater than 200 MPa, a yield strength greater than 100 MPa, and an electric resistivity greater than 50×10⁻⁸ ohm-meters. In specific embodiments, the stator frame may be formed of a steel alloy. The stator frame may include breaks, preventing the formation of loops that would otherwise lead to magnetic flux leakage in a diamagnetic material.

### CROSS REFERENCE TO RELATED APPLICATIONS

This application claims the benefit of U.S. Provisional Patent Application No. 63/572,910, filed Apr. 2, 2024, which is incorporated by reference herein in its entirety for all purposes.

### BACKGROUND

Axial flux motors are currently making inroads as the prime movers of the drivetrain of electric automobiles. For such applications, axial flux motors are ideal as prime movers due to the size and form factor attributable to their axially compact designs. Their form factor is also beneficial in certain other vehicle classes such as electric motorcycles, mopeds, and electric bicycles owing to their ability to be packaged more efficiently relative to the wheels of such vehicles. Furthermore, in the case of electric motors used for power generation in conjunction with internal combustion engines, the overall axial length of the engine and electric machine system is a challenge to package within tight spaces (e.g., passenger cars or tight spaces for installation in buildings). Accordingly, axial flux electric machines provide a key packaging benefit in these applications as well.

Axial flux electrical machines feature two main components: stators and rotors. The stator serves as the stationary part of the machine, housing coils or windings through which electrical currents flow. The electrical currents generate magnetic fields that interact with the rotors to induce rotational motion. The rotors typically consist of permanent magnets or magnetized material that interacts with the magnetic fields generated by the stator which induces the rotor to rotate. This distinctive axial arrangement of the stators and rotors enables efficient power transfer and compact design, making axial flux electrical machines suitable for the various applications mentioned above.

Stators play a crucial role in facilitating the conversion of electrical energy into mechanical energy in an axial flux electrical machine. These components endure high-temperature conditions due to the intense heat generated during operation, necessitating robust materials and meticulous design considerations. Assembling the various pieces of stators under such conditions poses significant challenges, demanding precision and expertise.

Each component must withstand the thermal stresses and maintain structural integrity to ensure efficient performance and longevity of the machine. Overcoming these assembly challenges requires innovative techniques and advanced manufacturing processes to achieve seamless integration and optimal functionality, ultimately enhancing the reliability and performance of electric flux axial machines in demanding operating environments.

### SUMMARY

This disclosure relates to axial flux machine stator frames for axial flux electric machines. The axial electric machines can be electric motors or electric generators. The stators can include stator frames made of specific materials and having specific configurations. The specific materials and configurations can be selected to improve the performance of the stator in terms of superior energy conversion efficiency, ease of assembly, and thermal performance. The specific materials and configurations can be selected to allow the stator to have sufficient structural strength such that it can serve as support for a bearing of the axial electric machine or serve as a portion of the housing of the axial electric machine.

Specific embodiments of the inventions disclosed herein disclose specific materials which can be used to form the stator frame with increased ease of manufacturing, specific configurations which can include breaks in the stator frame to improve electrical performance (e.g., reduce eddy currents) and ease of assembly, pockets to hold the pole pieces of the stator formed by spokes to improve the mechanical strength and ease of assembly, and air channels to improve thermal performance.

The stator frame may include an inner ring, an outer ring, a set of pockets, and a set of spokes. The set of spokes can connect the inner ring to the outer ring and form the set of pockets. The stator can also include a set of pole pieces that occupy the set of pockets. In specific embodiments of the invention, the pole pieces of the stator can each comprise a composite coil formed of a ribbon of conductive material and a ribbon of soft magnetic material. The composite coil can also include a ribbon of insulative material. Furthermore, the pole pieces can include a coating of electrically insulative material formed over and around (e.g., sheathing) the ribbon of conductive material of the composite coil. In specific embodiments disclosed herein, the coating of electrically insulative material can be a non-metallic sheathing layer surrounding a conductive core of the ribbon. Furthermore, the pole pieces can include a coating of electrically insulative material formed over and around (e.g., sheathing) the entire composite coil. In specific embodiments disclosed herein, the coating of electrically insulative material can include an insulative epoxy or other adhesive used to at least partially secure the pole piece in the pockets of the stator frame. In specific embodiments, the sheath of insulative material may prevent electrical contact between the pole pieces and the stator frame.

Using the approaches disclosed herein, a stator frame can exhibit superior electrical energy conversion characteristics and sufficient structural strength such that it can serve as a support for a bearing that extends through the center of the stator frame and can serve as a portion of the axial electrical machine housing. Each spoke of the stator could include an attachment means for attaching the stator frame to a housing of the axial electrical machine. For example, the large lobes (e.g., mounting lobes) located at the ends of the spokes could be secured to a housing of the electrical machine to which the stator was a part and could provide support for the bearing via the spokes of the stator frame. Furthermore, using the approaches disclosed herein, the stator frame can be used in a modular fashion in axial electrical machines having multiple configurations in terms of the number of stators, number of rotors, and number of shafts in the axial electrical machine.

In specific embodiments of the invention, a stator for an axial electric machine in accordance with the disclosures herein can be formed of materials that provide superior energy conversion efficiency (e.g., reduced eddy currents), ease of manufacturing, ease of assembly, and thermal performance. The specific materials and configurations can be selected to allow the stator to have sufficient structural strength such that it can serve as a support for a bearing of the axial electric machine or serve as a portion of the housing of the axial electric machine. In specific embodiments, the stator frame can be formed of steel alloy with nickel and chromium. In specific embodiments, the stator frame can be formed of stainless steel. In specific embodiments, the stator frame is formed of a diamagnetic metal with a tensile strength greater than 200 mega-Pascals (MPa), a yield strength greater than 100 MPa, and an electric resistivity greater than 50×10⁻⁸ ohm-meters.

Various factors were considered when selecting the materials described in the prior paragraph. For example, changing magnetic fields through a stator during operation of the axial electric machine can create eddy currents if the stator frame is made of an electrically conductive material. The loss because of these eddy currents is inversely proportional to the resistivity of the material. As such, increasing resistivity reduces losses and increases electrical energy conversion efficiency. Accordingly, a material such as aluminum would not result in good performance because the resistivity would be too low. However, using the approaches disclosed herein in which the stator frame includes breaks in the portion of the frame that forms the pockets for the pole pieces, the breaks (e.g., discontinuities) in the stator frame may prevent or reduce eddy currents. For example, since the pockets do not form complete loops, there is less of a risk of the magnetic field forming lossy eddy currents in a loop around each of the pole pieces and decreasing the electric energy conversion efficiency of the axial electric machine.

As another example, it is important for the magnetic flux created by the electrical current through the pole pieces to be applied fully to the permanent magnets in the rotors. As such, those of ordinary skill in the art would not usually use diamagnetic material to form a stator frame that completely surrounds a pole piece of a stator. However, using the approaches disclosed herein in which the stator frame includes breaks in the portion of the frame that forms the pockets for the pole pieces, diamagnetic materials can be used without the formation of loops leading to magnetic flux leakage. Accordingly, while stainless steel would not usually make a good material because it would lead to circulating currents in a closed loop of diamagnetic metal that holds a pole piece, with the inclusion of breaks in the frame, stainless steel and similar materials become viable options.

As another example, stators in high-speed axial electrical machines or axial electric machines which need to support high currents through the pole pieces can be required to operate in significantly elevated temperatures (e.g., greater than 150 degrees Celsius). Accordingly, polymeric materials are not generally favorable as they generally do not perform well in high temperature environments. As another example, metal-based materials are generally lower cost and are easy to manufacture using widely known manufacturing processes. As such, metal-based stator frames such as one formed of stainless-steel exhibits significant benefits in terms of mechanical strength and low cost. In specific embodiments, the stator frame can be a machined piece of metal or forged or cast as one piece of metal.

Those of ordinary skill in the art would usually use a material such as laminated electrical steel to form a stator frame. Laminated electrical steel is difficult to manufacture into a stator frame shape as compared to stainless steel or other nonelectrical steel which can be forged or punched from a single slug of material. However, using the approaches disclosed herein in which the electrical steel is integrated with the pole pieces removes the need for the frame to be made of laminated electrical steel. Accordingly, while stainless steel may not usually make a good material because it would not incorporate the benefits of electrical steel, with the integration of electrical steel in the pole pieces, stainless steel and similar materials become viable options for the stator frame.

The breaks in the stator frame may be arranged in a variety of ways. For example, in specific embodiments, the inner ring of the stator frame may have a first set of breaks that has the same cardinality as the set of pockets and the outer ring of the stator frame may have a second set of breaks that has the same cardinality as the set of pockets. The first set of breaks may be partial breaks that do not extend all the way through the stator frame in the axial direction of the axial electric machine in which the stator will be installed, and the second set of breaks may be complete breaks that do extend all the way through the stator frame in the axial direction. However, in alternative cases, the first set of breaks could be complete breaks, and the second set of breaks could be partial breaks. Furthermore, in alternative cases, the outer ring could include both the first set of breaks and the second set of breaks where only one of the breaks was a complete break where the other was a partial break. Furthermore, in alternative cases, the inner ring could include both the first set of breaks and the second set of breaks where only one of the breaks was a complete break where the other was a partial break.

Specific embodiments which include complete breaks in the stator frame exhibit certain benefits. For example, since the pockets do not form complete loops, there is less of a risk of the magnetic field forming lossy eddy currents in a loop around each of the pole pieces and decreasing the electric energy conversion efficiency of the axial electric machine. Furthermore, the breaks in the loop allow for ease of assembly as the pole pieces can be inserted into the pockets from one direction and the outer contacts of the pole pieces can extend through the outer and inner rings of the stator. The pole pieces can be inserted into the pockets from one direction and the outer contacts of the pole pieces can extend through the outer and inner rings of the stator. A double-sided pole piece may be loaded from one side of the stator with a half discontinuity and a full discontinuity.

In specific embodiments, the partial or complete breaks in the stator frame can include a fill material. The fill material can be selected to increase the strength of the stator frame. The material can also be selected such that it has a high electrical resistivity. For example, the partial or complete breaks could be filled with nichrome or some other material with high electrical resistivity. The fill material could be welded or otherwise fixedly attached to the stator frame and could provide structural support to the stator frame despite the absence of the underlying material at the partial or complete breaks.

In specific embodiments of the invention, a stator for an axial electric machine is provided. The stator comprises: a stator frame, an inner ring of the stator frame, an outer ring of the stator frame, a set of pockets, a set of pole pieces occupying the set of pockets, and a set of spokes of the stator frame. The set of spokes of the stator frame connects the inner ring to the outer ring and forms the set of pockets. The stator frame is formed of a diamagnetic metal with a tensile strength greater than 200 MPa, a yield strength greater than 100 MPa, and an electric resistivity greater than 50×10⁻⁸ ohm-meters.

In specific embodiments of the invention, a stator for an axial electric machine is provided. The stator comprises: a stator frame, an inner ring of the stator frame, an outer ring of the stator frame, a set of pockets, a set of pole pieces occupying the set of pockets, and a set of spokes of the stator frame. The set of spokes of the stator frame connects the inner ring to the outer ring and forms the set of pockets. The stator also comprises a first set of breaks in the stator frame that has the same cardinality as the set of pockets. The stator also comprises a second set of breaks in the stator frame that has the same cardinality as the set of pockets. At least one of the first set of breaks and the second set of breaks extends all the way through the stator frame.

In specific embodiments of the invention, a method of assembling a stator for an axial flux electric machine is provided. The method comprises inserting, from an axial side of a stator frame, a pole piece into a pocket of the stator frame such that a first contact of the pole piece extends through a first break in the stator frame and a second contact of the pole piece extends through a second break in the stator frame. The stator frame includes an inner ring, an outer ring, and a set of spokes. The pocket is part of a set of pockets. The set of spokes of the stator frame connects the inner ring to the outer ring and forms the set of pockets. The first break is part of a first set of breaks having the same cardinality as the set of pockets. The second break is part of a second set of breaks having the same cardinality as the set of pockets.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of components of a stator for an axial electric machine in accordance with specific embodiments of the inventions disclosed herein.

FIG. 2 provides an example of partial breaks in an inner ring and complete breaks in an outer ring in accordance with specific embodiments of the inventions disclosed herein.

FIG. 3 provides an example of a pole piece in accordance with specific embodiments of the inventions disclosed herein.

FIG. 4 provides an example of securing rings attached to a stator frame in accordance with specific embodiments of the inventions disclosed herein.

FIG. 5 provides an example of a stator frame that is coated in an insulating material in accordance with specific embodiments of the inventions disclosed herein.

FIG. 6 provides an example of air circulation features in accordance with specific embodiments of the inventions disclosed herein.

FIG. 7 provides an example of a complete assembled stator in accordance with specific embodiments of the inventions disclosed herein.

FIG. 8 provides an example of a coil tail of a pole piece attached, via an electrical connection, to another pole piece in the same stator disc in accordance with specific embodiments of the inventions disclosed herein.

FIG. 9 provides an example of a coil tail of a pole piece in a stator disc attached, via a vertical routing connector, to another pole piece in a different stator disc in accordance with specific embodiments of the inventions disclosed herein.

FIG. 10 provides an example of the edge of a stator stack with two stators, showing how a pole piece may connect to a routing connector in accordance with specific embodiments of the inventions disclosed herein.

FIG. 11 provides two example designs of busbars for stators in accordance with specific embodiments of the inventions disclosed herein.

FIG. 12 provides an example of a stator with one busbar and an example of a stator with two busbars in accordance with specific embodiments of the inventions disclosed herein.

FIG. 13 provides an example of a busbar bypassing a mounting hole of a mounting lobe in accordance with specific embodiments of the inventions disclosed herein.

FIG. 14 provides an example of a method for assembling a stator for an axial flux electric machine in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for axial flux electric machine stator frames in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to stators for axial electric machines are disclosed herein. The axial electric machines can be electric motors or electric generators. The stators can include stator frames made of specific materials and having specific configurations. The specific materials and configurations can be selected to improve the performance of the stator in terms of superior energy conversion efficiency, ease of assembly, and thermal performance. The specific materials and configurations can be selected to allow the stator to have sufficient structural strength such that it can serve as support for a bearing of the axial electric machine or serve as a portion of the housing of the axial electric machine.

Specific embodiments of the inventions disclosed herein disclose specific materials which can be used to form the stator frame, specific configurations which can include breaks in the stator frame to improve electrical performance and ease of assembly, pockets to hold the pole pieces of the stator formed by spokes to improve the mechanical strength and ease of assembly, and air channels to improve thermal performance.

In specific embodiments of the invention, the stator can be used in combination with the pole pieces disclosed in U.S. patent application Ser. No. 18/241,159 as filed on Aug. 31, 2023, which is incorporated by reference herein in its entirety for all purposes. Accordingly, the pole pieces of the stator can each comprise a composite coil formed of a ribbon of conductive material and a ribbon of soft magnetic material. The composite coil can also include a ribbon of insulative material as disclosed in U.S. patent application Ser. No. 18/241,159. The ribbon of conductive material can be at least partially sheathed in an insulating material as disclosed in U.S. patent application Ser. No. 18/241,159. Furthermore, the pole pieces can include a coating of electrically insulative material formed over and around (e.g., sheathing) the composite coil. In specific embodiments disclosed herein, the coating of electrically insulative material can include an insulative epoxy or other adhesive used to at least partially secure the pole piece in the pockets of the stator frame.

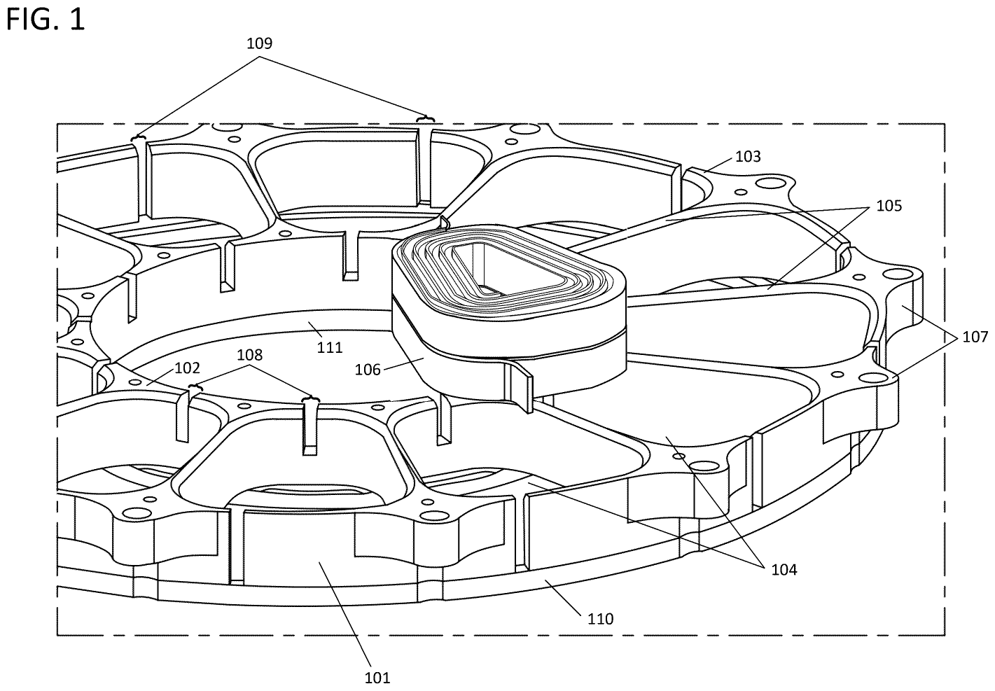

FIG. 1 illustrates an example of components of a stator for an axial electric machine in accordance with specific embodiments of the inventions disclosed herein. The stator can include stator frame 101 which includes inner ring 102 of stator frame 101, outer ring 103 of stator frame 101, set of pockets 104, and set of spokes 105 of stator frame 101. Set of spokes 105 of stator frame 101 can connect inner ring 102 to outer ring 103 and form set of pockets 104. The stator can also include a set of pole pieces 106 (one shown) that occupy set of pockets 104. Using the approaches disclosed herein, a stator frame such as the one shown in FIG. 1 can be incorporated into a stator and can exhibit superior electrical energy conversion characteristics and sufficient structural strength such that it can serve as a support for a bearing that extends through the center of the stator frame and can serve as a portion of the axial electrical machine housing.

Each spoke 105 of stator frame 101 could include a mounting lobe 107. Mounting lobes 107 may be an attachment means for attaching stator frame 101 to a housing of the axial electrical machine. For example, mounting lobes 107 located at the ends of spokes 105 could be secured to a housing of the electrical machine to which the stator was a part and could provide support for the bearing via spokes 105 of stator frame 101. Furthermore, using the approaches disclosed herein, the stator frame can be used in a modular fashion in axial electrical machines having multiple configurations in terms of the number of stators, number of rotors, and number of shafts in the axial electrical machine.

Stator frame 101 includes partial breaks 108 in inner ring 102 and complete breaks 109 in outer ring 103. Breaks 108 and 109 in stator frame 101 may allow for ease of assembly. For example, pole pieces 106 can be inserted into pockets 104 from one direction and the outer contacts of pole pieces 106 can extend through inner ring 102 and outer ring 103 of the stator. A double-sided pole piece may be loaded from one side of the stator with a half discontinuity and a full discontinuity.

In specific embodiments, stator frame 101 can be attached to rings 110 and 111 to secure pole pieces 106 to stator frame 101 or to otherwise support stator frame 101. For example, in FIG. 1, outer ring 103 of stator frame 101 is connected to ring 110 (e.g., a first ring) which closes off gaps formed by complete breaks 109 in outer ring 103. Inner ring 102 of stator frame 101 is connected to ring 111 (e.g., a second ring) which reinforces inner ring 102 to provide additional structure integrity to the stator.

In specific embodiments of the invention, the stator (e.g., stator frame 101, pole pieces 106, etc.) can be formed of materials that provide superior energy conversion efficiency, ease of manufacture, ease of assembly, and thermal performance. The specific materials and configurations can be selected to allow the stator to have sufficient structural strength such that it can serve as a support for a bearing of the axial electric machine or serve as a portion of the housing of the axial electric machine. In specific embodiments, stator frame 101 can be formed of steel alloy with nickel and chromium. In specific embodiments, stator frame 101 can be formed of stainless steel. In specific embodiments, stator frame 101 can be formed of a diamagnetic metal with a tensile strength greater than 200 mega-Pascals (MPa), a yield strength greater than 100 MPa, and an electric resistivity greater than 50×10⁻⁸ ohm-meters.

Various factors were considered when selecting the materials described in the prior paragraph. For example, changing magnetic fields through a stator during operation of the axial electric machine can create eddy currents if the stator frame is made of an electrically conductive material. The loss because of these eddy currents is inversely proportional to the resistivity of the material. As such, increasing resistivity reduces losses and increases electrical energy conversion efficiency. Accordingly, a material such as aluminum would not result in good performance because the resistivity would be too low. However, the approaches disclosed herein may reduce eddy currents by including breaks in the portion of the stator frame that forms the pockets for the pole pieces. The breaks (e.g., discontinuities) in the stator frame may prevent or reduce eddy currents. Since pockets 104 do not form complete loops, there is less of a risk of the magnetic field forming lossy eddy currents in a loop around each of the pole pieces and decreasing the electric energy conversion efficiency of the axial electric machine. For example, stator frame 101 includes partial breaks 108 in inner ring 102 and complete breaks 109 in outer ring 103.

As another example of factors considered in material selection for the stator frames disclosed herein, it is important for the magnetic flux created by the electrical current through the pole pieces to be applied fully to the permanent magnets in the rotors. As such, those of ordinary skill in the art would not usually use diamagnetic material to form a stator frame that completely surrounds a pole piece of a stator. However, using the approaches disclosed herein in which the stator frame includes breaks in the portion of the frame that forms the pockets for the pole pieces, diamagnetic materials can be used without the formation of loops leading to magnetic flux leakage. Accordingly, while stainless steel would not usually make a good material because it would lead to circulating currents in a closed loop of diamagnetic metal that holds a pole piece, with the inclusion of breaks in the frame, stainless steel and similar materials become viable options.

As another example of factors considered in material selection for the stator frames disclosed herein, stators in high-speed axial electrical machines or axial electric machines which need to support high currents through the pole pieces can be required to operate in significantly elevated temperatures (e.g., greater than 150 degrees Celsius). Accordingly, polymeric materials are not generally favorable as they generally do not perform well in high temperature environments. As another example, metal-based materials are generally lower cost and are easy to manufacture using widely known manufacturing processes. As such, metal-based stator frames (such as one formed of stainless steel) exhibit significant benefits in terms of mechanical strength and low cost. In specific embodiments, the stator frame can be a machined piece of metal, forged, or cast as one piece of metal.

Those of ordinary skill in the art would usually use a material such as laminated electrical steel to form a stator frame. Laminated electric steel may help control the magnetic fields and may generally reduce eddy current losses that occur when alternating current flows through a steel core of the motor. Laminated electrical steel is difficult to manufacture into a stator frame shape as compared to stainless steel or other nonelectrical steel which can be forged or punched from a single bar stock (e.g., slug) of material. However, using the approaches disclosed herein in which the electrical steel is integrated with the pole pieces removes the need for the frame to be made of laminated electrical steel. Accordingly, while stainless steel may not usually make a good material because it would not incorporate the benefits of electrical steel, with the integration of electrical steel in the pole pieces, stainless steel and similar materials become viable options for the stator frame.

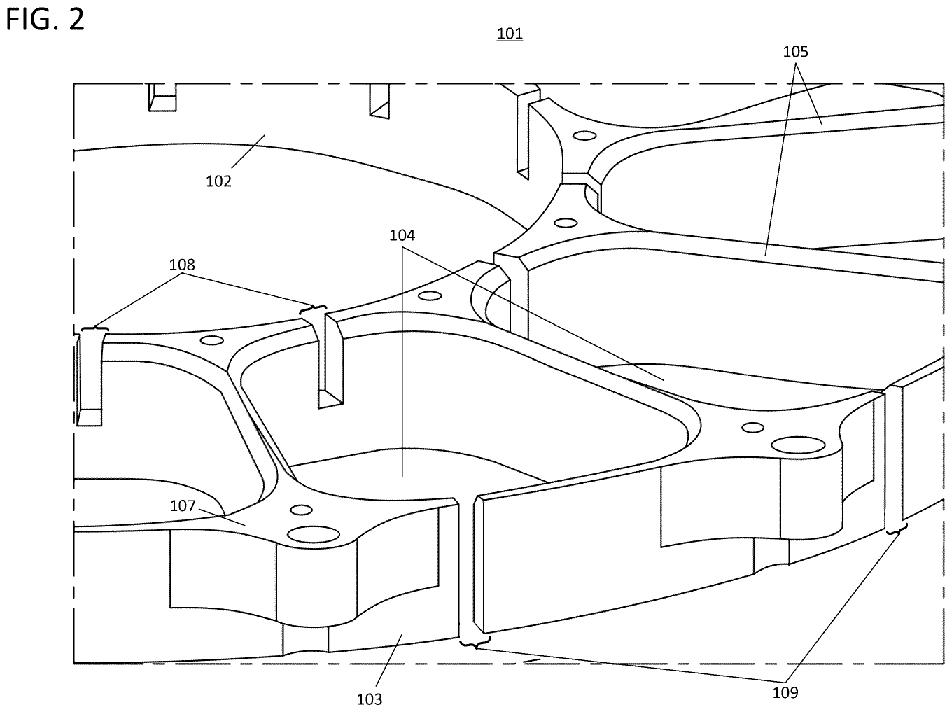

FIG. 2 shows partial breaks 108 of inner ring 102 and complete breaks 109 of outer ring 103 in accordance with specific embodiments of the inventions disclosed herein. Inner ring 102 has set of breaks 108 that has the same cardinality as set of pockets 104 and outer ring 103 has set of breaks 109 that has the same cardinality as set of pockets 104. In the illustrated case, set of breaks 108 are partial breaks that do not extend all the way through stator frame 101 in the axial direction of the axial electric machine in which the stator will be installed, and set of breaks 109 are complete breaks that do extend all the way through stator frame 101 in the axial direction. However, in alternative cases, the set of breaks of the inner ring could be complete breaks, and the set of breaks of the outer ring could be partial breaks. Furthermore, in alternative cases, the outer ring could include both the set of partial breaks and the set of complete breaks (e.g., only one of the sets of breaks is complete breaks and the other set of breaks are partial breaks). Furthermore, in alternative cases, the inner ring could include both the set of partial breaks and the set of complete breaks (e.g., only one of the sets of breaks is complete breaks and the other set of breaks are partial breaks). In specific embodiments, both the set of breaks in the inner ring and the set of breaks in the outer ring may be partial. Furthermore, in alternative cases, the inner ring may include more than one set of partial breaks, the outer ring may include more than one set of partial breaks, or both.

Specific embodiments which include complete breaks (such as breaks 109) in the stator frame exhibit certain benefits. For example, since the pockets (such as pockets 104) do not form complete loops, there is less of a risk of the magnetic field forming lossy eddy currents in a loop around each of the pole pieces and decreasing the electric energy conversion efficiency of the axial electric machine. Furthermore, the breaks in the loop allow for ease of assembly as the pole pieces can be inserted into the pockets from one direction and the outer contacts of the pole pieces can extend through the outer and inner rings of the stator.

In specific embodiments, the partial or complete breaks in the stator frame can include a fill material. The fill material can be selected to increase the strength of the stator frame. The material can also be selected such that it has a high electrical resistivity. For example, the partial or complete breaks could be filled (e.g., the portion of the break not filled by a coil tail of a pole piece) with nichrome or some other material with high electrical resistivity. The fill material could be welded or otherwise fixedly attached to the stator frame and could provide structural support to the stator frame despite the absence of the underlying structural material at the partial or complete breaks.

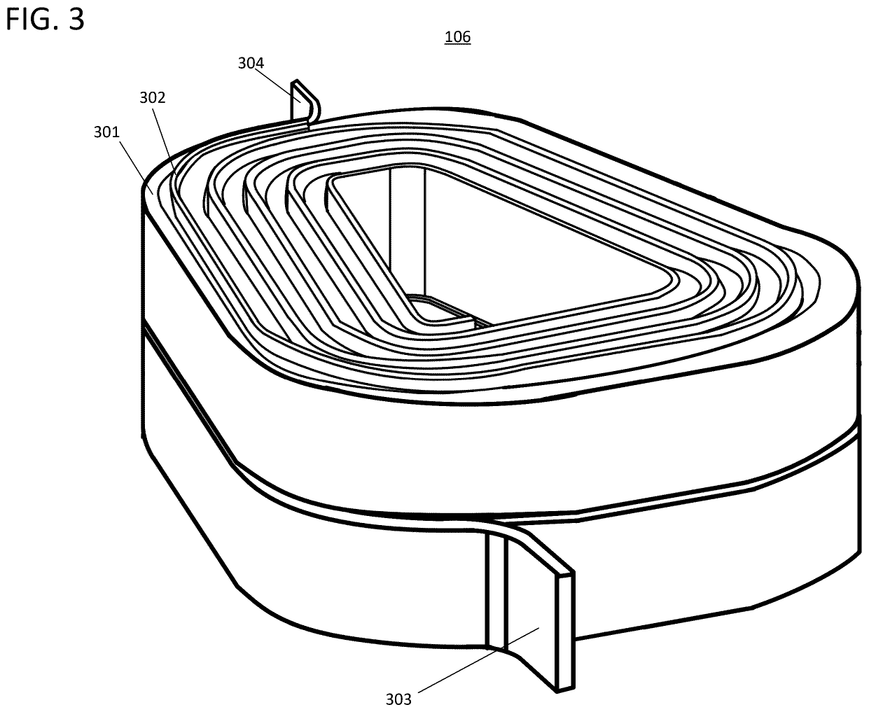

FIG. 3 illustrates an example of pole piece 106 in accordance with specific embodiments of the inventions disclosed herein. Pole piece 106 may be representative of a set of pole pieces of a stator. Pole piece 106 may comprise a composite coil formed of ribbon of conductive material 301 and ribbon of soft magnetic material 302. The composite coil can also include a ribbon of insulative material. Furthermore, pole piece 106 can include a coating of electrically insulative material formed over and around (e.g., sheathing) the composite coil. In specific embodiments disclosed herein, the coating of electrically insulative material can include an insulative epoxy or other adhesive used to at least partially secure the pole piece in the pockets of the stator frame.

In specific embodiments, pole piece 106 can be a double-sided pole piece with a first side that is opposite the second side in the axial direction of the axial electric machine. As illustrated, pole piece 106 can comprise a continuous composite coil that coils in from first outer contact 303 on the first side and coils out to second outer contact 304 on the second side. Accordingly, a rotor can be placed on either side of the stator and the same current can be applied to flow between first outer contact 303 and second outer contact 304 and produce the required magnetic field to influence both rotors in complementary fashion. Outer contacts 303 and 304 of pole piece 106 could extend through the inner or outer ring of the stator frame at the breaks. First outer contact 303 of the composite coil of pole piece 106 could be part of a set of first outer contacts of the set of composite coils of the set of pole pieces of the stator; and second outer contact 304 of the composite coil could be part of a set of second outer contacts of the set of pole pieces. The first set of outer contacts could extend through the first set of breaks. The second set of outer contacts may extend through the second set of breaks. In embodiments in which the break is partial, the frame could support the pole piece at the break; a securing ring may support the other side (e.g., open side) of the break. In embodiments in which the break is complete, the two securing rings could support the pole piece, with one ring closing off either side of the break.

Pole piece 106 could be easily inserted into the pockets of a stator frame in accordance with specific embodiments of the inventions disclosed herein in which the stator frame includes two sets of breaks each with a cardinality equal to the set of pockets. Pole piece 106 can be inserted into the pockets of the stator frame from one direction. Outer contacts 303 and 304 of pole pieces 106 can extend through the outer ring and the inner ring of the stator. A double-sided pole piece may be loaded from one side of the stator with a half discontinuity and a full discontinuity.

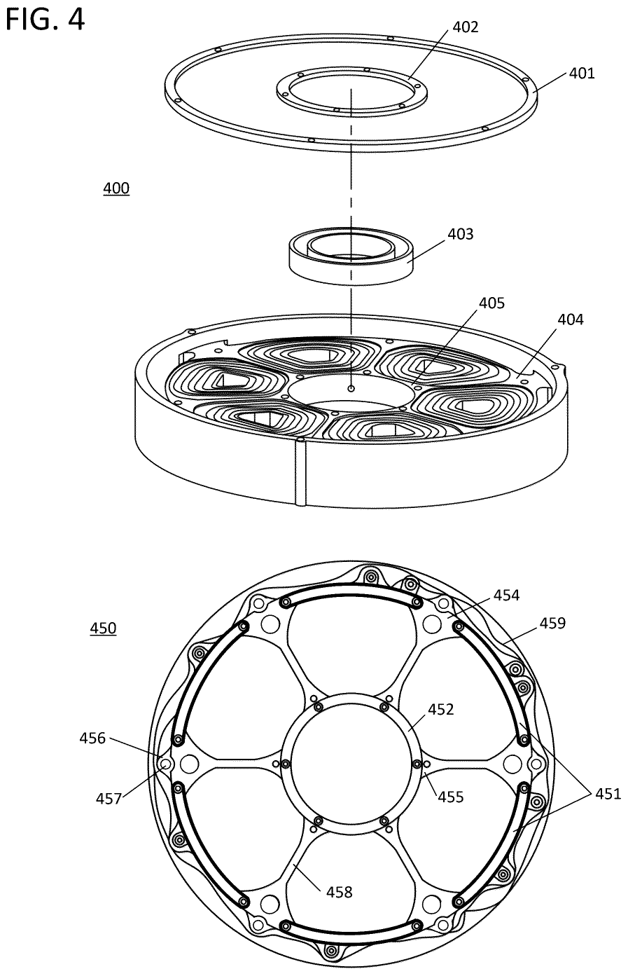

FIG. 4 illustrates an example of securing rings attached to a stator frame to secure pole pieces to the stator or to otherwise support the stator frame in accordance with specific embodiments of the inventions disclosed herein. A first securing ring may be fastened to the stator frame and may cover the second set of breaks on a first side; and a second securing ring may be fastened to the stator frame and may cover the first set of breaks. At least one of the first set of breaks and the second set of breaks may extend all the way through the stator frame. For example, the outer ring of the stator frame may be connected to a first ring which may cover or close off a gap formed by the complete breaks in the outer ring. The inner ring of the stator frame may be connected to a ring which may reinforce the inner ring to provide additional structure integrity to the stator. Rings could be placed on the stator frame after the pole pieces have been inserted into the pockets of the stator in order to secure the pole pieces to the stator. The rings could block off breaks in the stator frame which were used to insert the pole pieces into the stator frame and then be fastened to the stator frame using screws or adhesive (or another fastener) to keep the ring in place and prevent the pole pieces from moving relative to the stator frame. An electrically insulative adhesive may isolate the composite coils of the pole pieces and the stator frame. Securing rings (e.g., securing rings 401, 402, 451, and 452) may be made of G11 or another insulative material. Alternatively, securing rings could be isolated from the stator frame by an electrophoretic coating on the ring or on the stator frame.

Assembly 400 shows an exploded view of the stator with outer securing ring 401, inner securing ring 402, and bearing support 403. In specific embodiments, outer securing ring 401 may be connected to outer ring 404 of the stator frame and may cover (e.g., close off) a gap formed by complete breaks in outer ring 404. In specific embodiments, inner securing ring 402 may be connected to inner ring 405 of the stator frame, which may reinforce inner ring 405 to provide additional structure integrity to the stator. In specific embodiments, inner securing ring 402 may be connected to inner ring 405 of the stator frame, which may cover (e.g., close off) a gap formed by complete breaks in inner ring 405. In specific embodiments, outer securing ring 401 may be connected to outer ring 404 of the stator frame, which may reinforce outer ring 404 to provide additional structure integrity to the stator. Complete breaks and partial breaks may be located in inner ring 405 or outer ring 404 of the stator frame.

Assembly 450 shows a top view of another stator design with outer securing ring 451 and inner securing ring 452. Assembly 450 shows busbar 459 surrounding outer securing ring 451. Securing ring 451 may be segmented to make space for mounting lobes 456 with mounting holes 457. For example, the space between mounting holes 457 and the outer diameter of a rotor connected to the stator may be small. This space may be small enough that a securing ring of this width may not add significant structural support. Accordingly, gaps between segments of outer securing ring 451 may be radially aligned with mounting lobes 456 (e.g., mounting holes 457). As spokes 458 may be aligned with mounting lobes 456, outer securing ring 451 may be segmented such that gaps between segments of outer securing ring 451 may be radially aligned with the set of spokes 458.

In specific embodiments, outer securing ring 451 may be connected to outer ring 454 of the stator frame and may cover (e.g., close off) a gap formed by complete breaks in outer ring 454. In specific embodiments, inner securing ring 452 may be connected to inner ring 455 of the stator frame, which may reinforce inner ring 455 to provide additional structure integrity to the stator. In specific embodiments, inner securing ring 452 may be connected to inner ring 455 of the stator frame, which may cover (e.g., close off) a gap formed by complete breaks in inner ring 455. In specific embodiments, outer securing ring 451 may be connected to outer ring 454 of the stator frame, which may reinforce outer ring 454 to provide additional structure integrity to the stator. Partial breaks may be located in inner ring 455 or outer ring 454.

Although two embodiments, assembly 400 and assembly 450, are shown in FIG. 4, other embodiments of securing rings are possible. For example, only a single securing ring may be used (e.g., an inner ring or an outer ring). Alternatively, inner and outer securing rings may be added to both sides of the stator such that the stator includes an inner securing ring on a first side, an inner securing ring on a second (axially opposite) side, an outer securing ring on the first side, and an outer securing ring on the second side. The securing rings could be formed of insulative material. Alternatively, the securing rings could be isolated from the stator frame by an electrophoretic coating on the ring or on the stator frame.

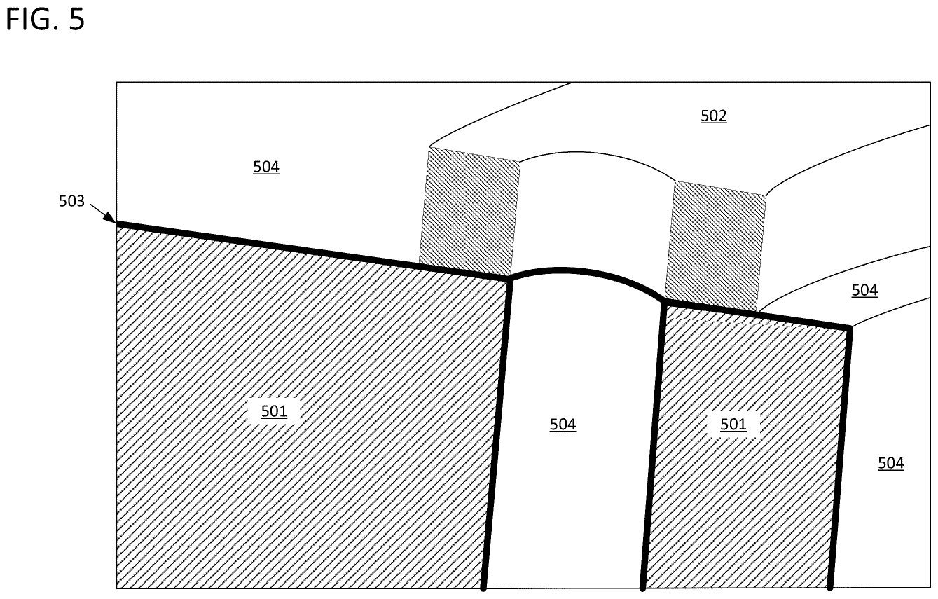

FIG. 5 illustrates a cut view of stator frame 501 and securing ring 502 where stator frame 501 is coated in an insulating material 503 in accordance with specific embodiments of the inventions disclosed herein. Insulating material 503 may coat surfaces 504 of stator frame 501. The entire stator frame could be covered in an electrically insulative electrophoretic coating such that securing rings may be isolated from the stator frames and there was no potential for eddy currents to be formed through an electrical connection between the stator frame and the securing rings. The securing rings could be made of the same material as the stator frame and be insulated therefrom using such a coating. Alternatively, the securing rings could themselves be formed of an electrically insulating material. For example, the rings could be formed of G-11 high temperature glass cloth epoxy.

The insulating material may isolate an inner securing ring (e.g., securing ring 502) from the stator frame, an outer securing ring from the stator frame, and the composite coils from the stator frame. The composite coils of the pole pieces may be sheathed in an insulating material. In specific embodiments, the insulating coating on the stator frame could also separate the frame from the outer contacts of the pole pieces that are routed through the breaks in the outer and/or inner ring. In particular, when the break is partial, and the partial break may support the contact and the coating can isolate the point at which the outer contact of the pole piece would otherwise have rested on the frame material. In specific embodiments, the coating can generally isolate the pole pieces from the stator frame.

In specific embodiments of the invention, the pole piece (e.g., composite coils) and the frame can be further separated by an electrically insulative adhesive. The electrically insulative adhesive can keep the pole pieces in the pockets; securing rings can serve as a backup in case the adhesive fails. The adhesive, or other epoxy, could also isolate the outer connections of the pole pieces from the stator frame at the point at which they are routed through the breaks in the stator frame.

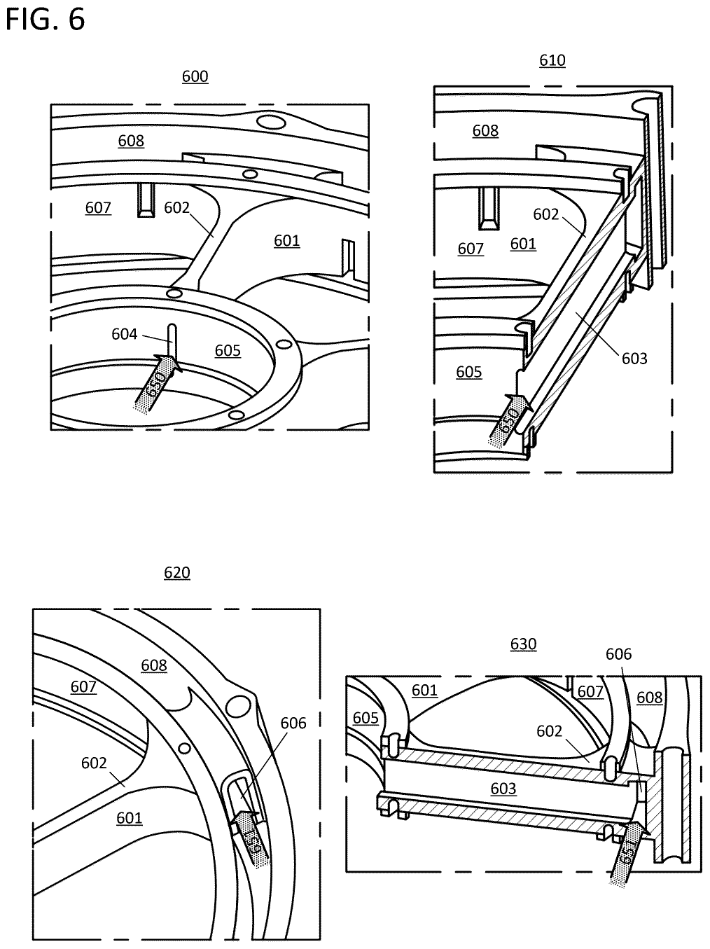

FIG. 6 illustrates examples of air circulation features in accordance with specific embodiments of the inventions disclosed herein. The air circulation features are shown in views 600, 610, 620, and 630. View 600 shows a portion of stator frame 601 with orifice 604. View 610 shows a cut view of the portion of stator frame 601 in view 600, showing the inside of the radial portion of air channel 603 connected to orifice 604. View 620 shows a portion of stator frame 601 with orifice 606. View 630 shows a cut view of the portion of stator frame 601, showing the inside of the radial portion of air channel 603 connected to orifice 604 and the inside of the tangential portion of air channel 603 connected to orifice 606.

Stator frame 601 can include air circulation features to improve the thermal performance of the stator. The features could be integrated with spokes 602 of stator frame 601. The features could include a set of air channels 603 in the set of spokes 602. Stator frame 601 could include a first set of orifices 604 of the set of air channels 603 proximate inner ring 605 and a second set of orifices 606 of the set of air channels 603 proximate outer ring 607. Airflow 650 shows how air would be pulled from the center of the stator to the outer rim 608 and would then be pushed through and out of air channel 603 in spokes 602, exiting outside the outer radius of the stator. Airflow 651 shows how the air may flow through tangential portion of air channel 603. The tangential portion of air channel 603 extends tangentially along the outer radius of the stator, moving across the spoke of the stator frame and connecting with the radial portion of air channel 603. The air could be moved via the motion of the rotor or rotors as they spin proximate to the stator. As this airflow feature goes through the center of the spokes, what would otherwise be one of the hottest portions of the stator frame will instead cool a large surface area on the interior of the spoke, producing superior thermal performance in the stator. Furthermore, since the airflow feature connects the center of the stator to the outside of the stator, the hottest portion of the stator is connected directly to the coolest part to thereby also significantly improve thermal performance.

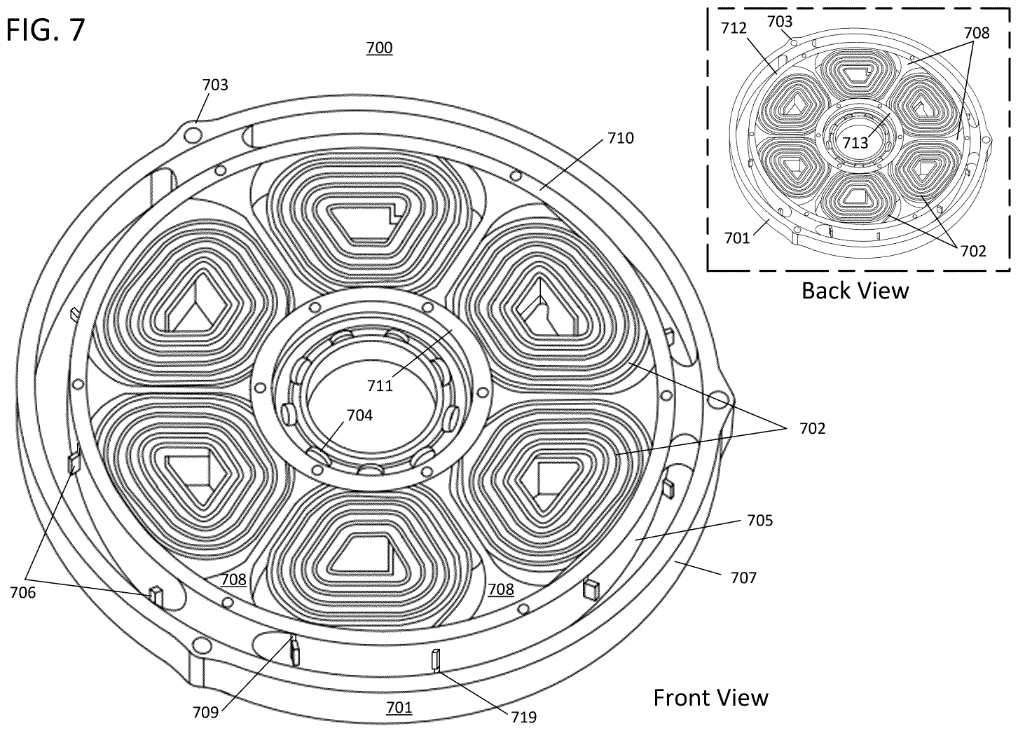

FIG. 7 illustrates an example of a complete assembled stator 700 in accordance with specific approaches disclosed herein. As illustrated, both sides of stator 700 include two rings (support rings 710 and 711 on the front side and support rings 712 and 713 on the back side) to provide structural support to stator 700 and keep pole pieces 702 in position in stator frame 701. Stator 700 also includes attachment means (e.g., mounting lobes 703) so that a portion of stator 700 may be used as a portion of the axial electric machine housing and provide support to bearing 704 at the center of stator 700. Stator frame 701 may include a portion or section of the housing and bearing mount. Stator 700 also includes breaks in outer ring 705 of stator frame 701 to provide space for outer contacts 706 of pole pieces 702 to be threaded through.

In stator 700, outer ring 705 has two partial breaks per pole piece 702 which form openings in outer ring 705. Partial breaks 709 are on the top portion of the radial edge of outer ring 705. Partial breaks 719 are on the bottom portion of the radial edge of outer ring 705. In this case, a complete break could be added to outer ring 707 in addition to the two partial breaks 709 and 719 shown or a complete break could be formed in the inner ring of stator frame 701 (covered from view by support rings 711 and 713).

Support rings may be arranged in various ways for specific embodiments. When there are no (partial or complete) breaks in the inner ring, then in specific embodiments, support rings 711 and 713 may be omitted. In specific embodiments, all partial breaks may be on the top portion of outer ring 707. In this case, support ring 712 may be omitted from the stator, as no partial gaps open at the bottom of outer ring 707 and so the retention of the ring may not be needed to keep the pole pieces in place. In specific embodiments, all partial breaks may be on the bottom portion of outer ring 707. In this case, support ring 710 may be omitted from the stator, as there are no partial gaps open at the top of outer ring 707. In specific embodiments, outer contacts of the pole pieces may point inward toward the center of the stator such that (partial or complete) breaks in the stator frame are in the inner ring and not the outer ring. In this case, the one or more support rings for the outer ring (e.g., support rings 710 and 712) may be omitted.

In stator 700, stator frame 701 includes a third ring, the most outer ring 707, which includes three attachment means (e.g., mounting lobes 703) to connect to a housing for the axial electric machine. In specific embodiments, outer ring 707 may be considered part of the housing. As shown, only every other spoke 708 extends to the most outer ring 707 of stator frame 701. Reducing the number of spokes that extend all the way to outer ring 707 may reduce the weight of the stator, improving efficiency. Outer ring 707 may improve the structural integrity of stator 700 even as the number of spokes is reduced.

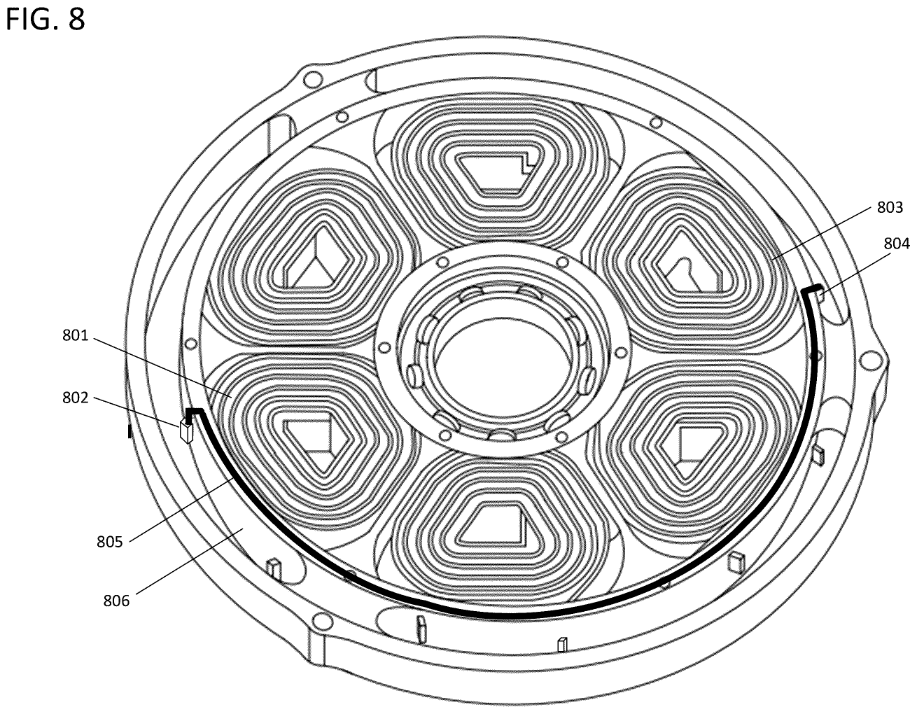

FIGS. 8-10 illustrate examples of pole pieces extending through the breaks in the stator frame in accordance with specific embodiments of the inventions disclosed herein. As mentioned previously, the conductive material of the composite coils of the pole pieces may be at least partially sheathed in insulating material (e.g., enamel). To electrically connect one pole piece to other portions of the stator, the insulative portion of the conductive material may be removed at a contact point. The conductive material may be attached to an electrical connections via solder, laser weld, or another method. The conductive material may be bent or otherwise adjusted to create a larger contact surface area with the electrical connections.

In specific embodiments, an axial flux electric machine may include a stack of multiple stators and/or rotors. The stators may be electrically connected to form a stack of multiple stator discs. Similarly, the rotors may be electrically connected to form a stack of multiple rotor discs.

FIG. 8 shows coil tail 802 of pole piece 801 attached, via electrical connection 805, to coil tail 804 of pole piece 803 in accordance with specific embodiments of the inventions disclosed herein. The coil tail can be a portion of the conductive material of a pole piece that has been stripped of insulative sheathing and extended through a break in the stator frame. Electrical connection 805 (shown as a thick black line) may be a busbar. Although shown as traversing the top of ring 806 of the stator frame, in specific embodiments, the electrical connection may travel around the outer diameter of ring 806.

Different portions of the stator may be organized into different phases. Phases may be turned on in sequence so that the magnets on the rotor are constantly being pulled forward and pushed from behind. Coil tail 802 may extend out radially through a break (e.g., slit) in the stator frame then bend so that coil tail 802 follows along the stator in the tangential direction. In specific embodiments, a coil tail of a first coil could follow around the circumference of the stator and then contact a second coil that is part of the same phase as the first coil. In specific embodiments, the coil tail could contact a second coil that is part of an opposite phase and that is coiled in the opposite direction.

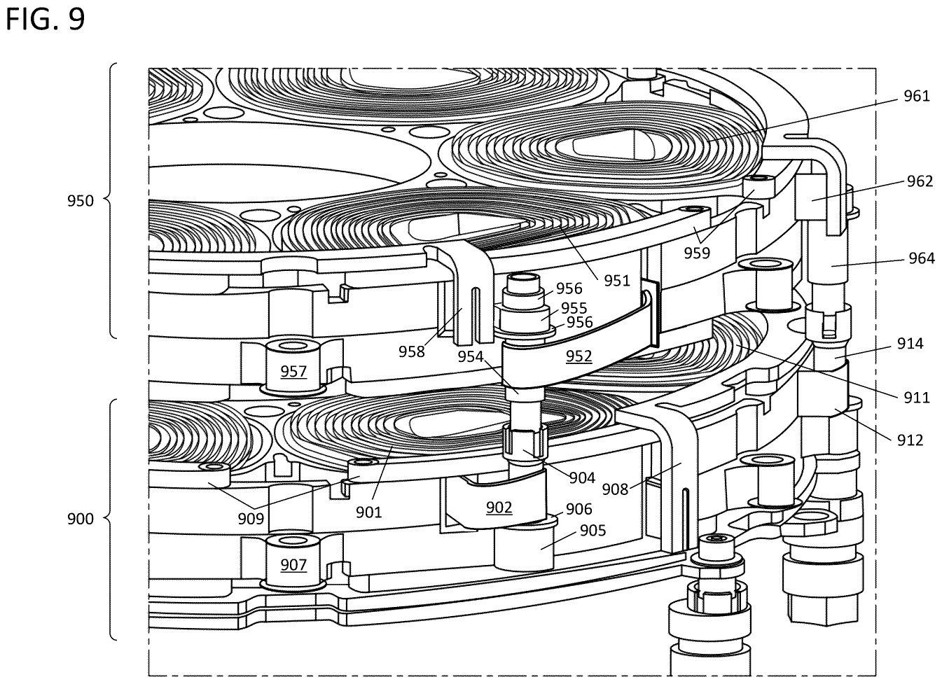

FIG. 9 shows coil tail 902 of pole piece 901 in stator disc 900 attached, via a vertical routing connector, to coil tail 952 of pole piece 951 in stator disc 950 in accordance with specific embodiments of the inventions disclosed herein. The vertical routing connector may be made up of lower connector piece 904 and upper connector piece 954, which may be electrically conductive. Vertical routing connectors may allow multiple stators to be stacked to form an axial flux electric machine with multiple stators. Although two stator discs are shown, more stator discs may be included in the stack. Subsequent stator discs may be stacked in a manner similar to that shown for stator discs 900 and 950. FIG. 9 also shows mounting lobes 907 and 957, busbars 908 and 958, and segmented outer support rings 909 and 959.

Connector piece 904 may be electrically isolated from the frame of stator disc 900, which may include mounting lobe 907. For example, insulator material 906 may be inserted between connector piece 904 and connector lobe 905 such that insulator material 906 surrounds the portion of connector piece 904 that is surrounded by connector lobe 905. As another example, connector lobe 905 may be made of an insulating material such that connector piece 904 is insulated from the stator frame (e.g., which may be a conductive material such as stainless steel). Alternatively, connector lobe 905 may be made of a conductive material (e.g., stainless steel) but may be coated with an insulating material, at least on the inside diameter of the connector hole, such that connector piece 904 is insulated from the stator frame (e.g., which may be stainless steel). Alternatively, connector piece 904 may be coated in an insulative material at the portion surrounded by connector lobe 905, but not be coated in insulative material where routing connector is in contact with connector piece 954. Connector piece 954 may similarly be electrically isolated from the frame of stator disc 950. For example, insulator material 956 may be inserted between connector piece 954 and connector lobe 955.

Connector piece 904 may be electrically coupled to connector piece 954. FIG. 9 may show a slightly exploded view, as, after assembly is complete, the bottom of upper connector piece 954 may contact the top face of the cylindrical portion of connector piece 904 and may contact the inner sides of the top prongs of connector piece 904. A screw or other fastener may be used to fasten upper connector piece 954 to lower connector piece 904. For example, upper connector piece 954 may be hollow (e.g., threaded), with the hollow portion aligning with a hole (e.g., threaded) in lower connector piece 904. A screw or bolt may use the hollow portion and the hole to fasten stator discs 900 and 950 together. The screw (or other fastener) may be electrically conductive or not.

Each pole piece may be connected to a connector piece. For example, coil tail 912 of pole piece 911 in stator disc 900 may be attached, via a vertical routing connector, to coil tail 962 of pole piece 961 in stator disc 950. The vertical routing connector may be made up of lower connector piece 914 and upper connector 964. Other pole pieces may be similarly connected.

Connector pieces 904 and 954 may allow multiple stators to be stacked. In the example of FIG. 9, the stator disc 900 and stator disc 950 may be congruent and aligned (e.g., not rotated relative to each other). Connector piece 954 may extend upwards to have top prongs similar to that of connector piece 904. The top of connector piece 954 may then electrically connect with a connector piece of a third stator disc (not shown). This third connector piece may have a portion similar to connector piece 954. In specific embodiments, stators may be connected in a clocked or staggered clocked pattern. For example, two stator discs may be congruent, but the second stator disc may be rotated slightly compared to the first stator disc. A third stator disc in the stack may be rotated in the same direction as the second stator disc or may be rotated in the opposite direction such that it aligns with the first stator disc.

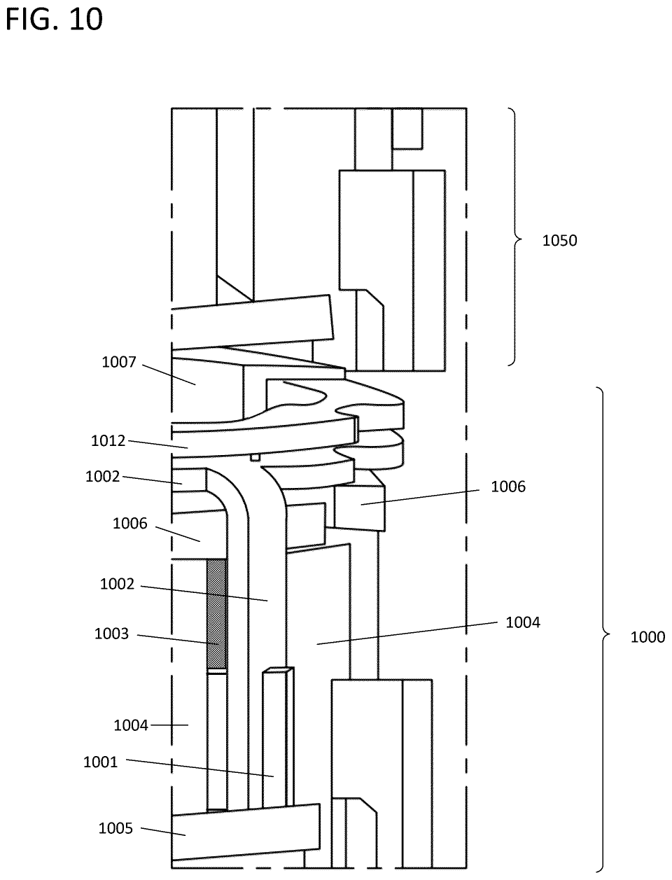

FIG. 10 shows a side view of an edge of a stator stack with stators 1000 and 1050 in accordance with specific embodiments of the inventions disclosed herein. In FIG. 10, the center of the stacked stators is to the left, outside the frame of view, and the axis of the axial flux machine is oriented vertically. FIG. 10 shows coil tail 1001 of a pole piece (of stator 1000) attached to routing connector 1002, which may be axially directed (e.g., out of the plane of the coil) at the area of attachment. Connector 1012 may be attached to a pole piece different from the pole piece connected to connector 1002. Routing connectors 1002 and 1012 may be busbars. Coil tail 1001 may pass through break 1003 in stator frame 1004. Breaks in stator frame 1004 may be capped by segmented support rings. For example, support ring 1005 and support ring 1006 may cap respective ends of complete break 1003. Support ring 1006 may include clocking tab 1007 with a slit for connector 1002 as well as a slit for connector 1012. Clocking tab 1007 may increase the ease of installation of these features.

Coil tail 1001 may pass through a slit in connector 1002. The connector (e.g., busbar) may arc around all or a portion of the stator and may be neutral or may be a phase lead (e.g., A, B, C). Phase lead busbars may all connect to (e.g., terminate at) a neutral busbar (e.g., at the end of a stack of stators). The connector may surround the outer rim of the stator frame (e.g., the busbar may have a larger diameter than the outer diameter of the stator frame, shown in assembly 450) or the connector may be axially adjacent to the stator frame (e.g., the busbar may have a similar diameter as the stator frame) as shown in FIG. 10. The stators may be oriented such that the inverter leads may be on the drive side or on the opposite side.

The coil wire of the pole piece may be coated in an insulative material; to electrically connect to connector 1002, the insulative portion of the coil wire may be removed at the contact point of coil tail 1001 and routing connector 1002. Coil tail 1001 (e.g., ribbon of wire) may pass through the slit in connector 1002 and may attach to connector 1002 via a solder or welded joint (or other method).

Connector 1002 may be easy to manufacture. For example, connector 1002, as a 2D shape, may be punched from a single sheet of material (e.g., metal) and then the axially directed portions of connector 1002 may be bent (e.g., 90 degrees) to match the 3D shape shown in FIG. 10. For example, a sheet of metal copper may be 2D laser cut to fit into the channel of the outer diameter arc of the stator. The slit in connector 1002, through which coil tail 1001 protrudes, may also be easy to manufacture (e.g., cut). The axially-directed portions of connector 1002 may be bent and slit. Clocking tab 1007 may orient and align the slit of connector 1002 with coil tail 1001.

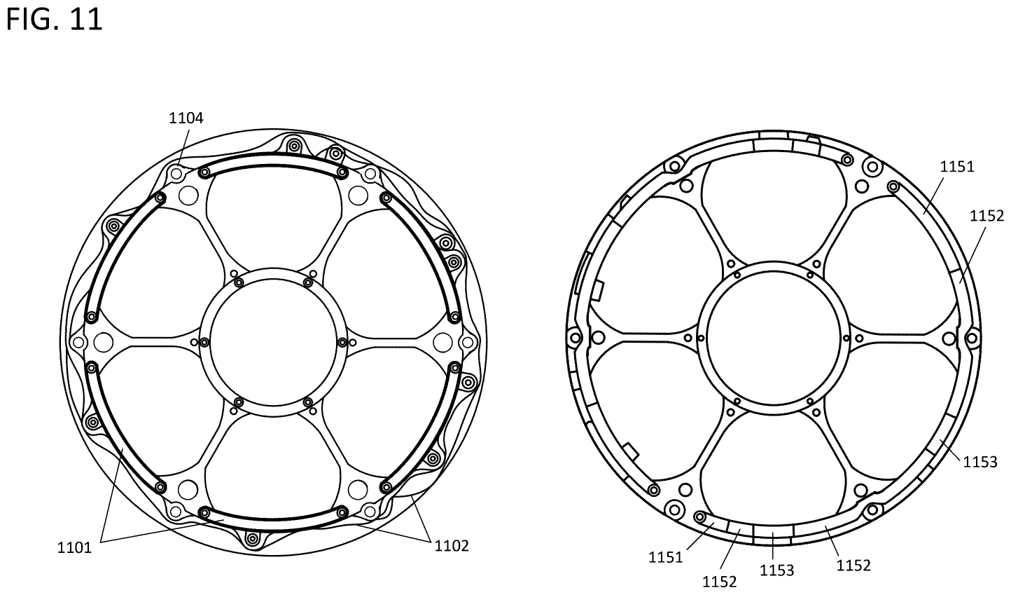

FIG. 11 shows top views of two designs of busbars for stators in accordance with specific embodiments of the inventions disclosed herein. In design 1100, busbar 1102 surrounds the outer rim (and mounting lobes 1104) of the stator frame. In design 1150, busbar 1152 is axially adjacent to the stator frame. Design 1150 may be similar to the connector design used in stator 1000. Both design 1100 and design 1150 include an inner ring, an inner supporting ring, spokes, an outer ring, an outer supporting ring, mounting lobes, and one or more busbars. Busbars may traverse around all or a portion of the stator and may be neutral or may be a phase lead (e.g., A, B, C). Phase lead busbars may all connect to (e.g., terminate at) a neutral busbar (e.g., at the end of a stack of stators).

Segmented securing rings 1101 and 1151 may be segmented to provide clearance for the mounting holes. For example, the space between the mounting holes and the outer diameter of a rotor connected to the stator may be small enough that a securing ring of this width would not add significant structural support. Accordingly, gaps between segments of outer securing rings 1101 and 1151 may be radially aligned with the mounting lobes (e.g., mounting holes). As the spokes may be aligned with the mounting lobes, outer securing rings 1101 and 1151 may be segmented such that gaps between segments may be radially aligned with the spokes.

In design 1100, busbar 1102 surrounds the outer rim (and mounting lobes) of the stator frame, which may add to the diameter of the stator, making a less compact design. In design 1150, busbar 1152 is axially adjacent to the stator frame and covers portions of securing ring 1151. Securing ring 1101 may include clocking tabs 1153. Clocking tabs 1153 may include slits for busbar 1152, such that a portion of the clocking tab 1153 is axially above a portion of busbar 1152 and another portion of clocking tab 1153 (e.g., part of securing ring 1151) may be below that portion of busbar 1152. Busbar 1152 may include a notch (e.g., indent, etc.) that catches on clocking tab 1153 during assembly. The notch may be located such that when it aligns with (e.g., catches on) the edge of clocking tab 1153, the slit in busbar 1152 and a break in the stator frame may be aligned. A coil tail of a pole piece may thread through the break in the stator frame and be electrically connected to busbar 1152. Accordingly, clocking tab 1007 may increase the ease of installation of these features.

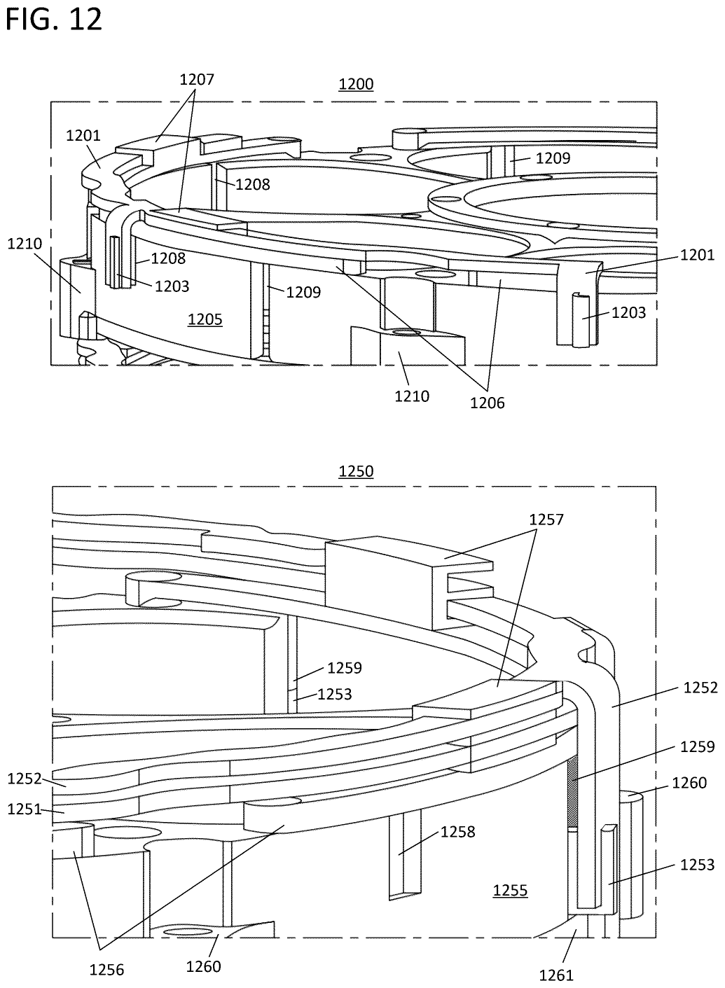

FIG. 12 shows stator 1200 with busbar 1201 and stator 1250 with busbars 1251 and 1252 in accordance with specific embodiments of the inventions disclosed herein. For stator 1200, the center is to the right; for stator 1250, the center is to the left (outside of view).

Coil tails 1203 of pole pieces (not shown) of stator 1200 may be attached to busbar 1201, which may be axially directed (e.g., out of the plane of the coil) at the area of attachment and then arc around (e.g., concentrically with) stator frame 1205. Stator 1200 also includes segmented securing ring 1206 with clocking tabs 1207. Stator frame 1205 includes partial breaks 1208, complete break 1209, and mounting lobes 1210. The portion of stator 1200 shown may be similar to other portions of the stator that are not shown. Coil tails 1203 may pass through partial breaks 1208 in stator frame 1205. Breaks 1208 may be capped by segmented support ring 1206. Support ring 1206 may include clocking tabs 1207 with a slit for busbar 1201, which may increase the ease of installation of busbar 1201. Clocking tabs 1207 may orient busbar 1201 with the coil tails 1203. Busbar 1201 may curve to provide clearance for fasteners (not shown) attached to mounting lobes 1210.

Coil tail 1253 of a pole piece (not shown) of stator 1250 may be attached to busbar 1252, which may be axially directed at the area of attachment and then arc around stator frame 1255. Stator 1250 also includes segmented securing ring 1256 with clocking tabs 1257. Stator frame 1255 includes partial breaks 1258, complete break 1259, and mounting lobes 1260. The portion of stator 1250 shown may be similar to other portions of the stator that are not shown. Coil tails 1253 may pass through complete breaks 1259 in stator frame 1255. Breaks 1259 may be capped by segmented support ring 1256 on top and segmented support ring 1261 on bottom. Busbars 1251 and 1252 may curve to provide clearance for fasteners (not shown) attached to mounting lobes 1260. Support ring 1256 may include clocking tabs 1257 with a slit for busbar 1251 and another slit for busbar 1252. Clocking tabs 1257 may increase the ease of installation of busbars 1251 and 1252. Clocking tabs 1257 may orient busbars 1251 and 1252 with coil tails 1253. In the illustrated embodiments, clocking tabs 1257 also add structural integrity to the stator and assure that bus bars for routing signals for different phases of the axial electric machine are kept isolated.

Busbars may arc around all or a portion of the stator and may be neutral or may be a phase lead (e.g., A, B, C). Phase lead busbars may all connect to (e.g., terminate at) a neutral busbar (e.g., at the end of a stack of stator discs). The stators may be oriented such that the inverter leads may be on the drive side or on the opposite side. Coil tails (e.g., ribbon of wire) may pass through the slits in the busbars and may attach to the busbars via a solder or welded joint (or other method). The coil wire of the pole piece may be coated in an insulative material; the insulative portion of the coil wire may be removed at the contact point of coil tails and the busbars to electrically connect these features.

Busbars may be easy to manufacture. For example, a busbar, as a 2D shape, may be punched from a single sheet of material (e.g., metal) and then the axially directed portions of the busbar may be bent (e.g., 90 degrees) to match the 3D shapes shown in FIG. 12. For example, a sheet of metal copper may be 2D laser cut to fit into the channel of the outer diameter arc of the stator. The slit in the busbars, through which the coil tails protrude, may also be easy to manufacture (e.g., cut). The axially-directed portions of the busbars may be bent and slit.

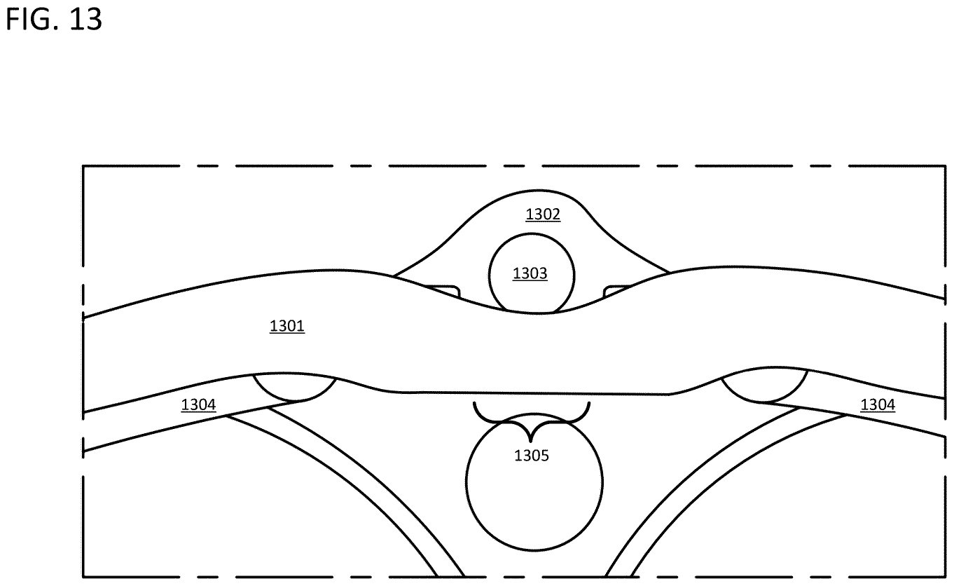

FIG. 13 shows busbar 1301 bypassing mounting hole 1303 of mounting lobe 1302 in accordance with specific embodiments of the inventions disclosed herein. Various geometries of the axial flux electric machine that includes busbar 1301 may constrain geometries of busbar 1301. Busbar 1301 may substantially align with segmented outer securing ring 1304. Mounting lobe 1302, busbar 1301, and outer securing ring 1304 may be arranged compactly (e.g., within a narrow ring-shape) to save space.

Mounting hole 1303 may constrain busbar 1301 and outer securing ring 1304. Busbar 1301 may bypass mounting hole 1303 by curving around mounting hole 1303. Busbar 1301 may be thinner at region 1305 radially adjacent to mounting hole 1303. Outer securing ring 1304 may be segmented such that the gaps between the segments align with mounting hole 1303. Mounting hole 1303 may remain clear (e.g., uncovered) such that a fastener may have unhindered access to mounting hole 1303. The fastener may attach the stator (e.g., stator disc) to a motor housing. In specific embodiments, mounting lobe 1302 may be considered part of the motor housing.

A rotor (not shown) may constrain busbar 1301 and outer securing ring 1304. The rotor may spin relative to, and coaxial with, the stator. The inner diameter of busbar 1301 and the inner diameter of securing ring 1304 may be slightly larger than the outer diameter of the rotor. This may prevent the rotor from contacting these features while rotating, preventing damage to the machine, rotor slowing, heat generation, and other issues.

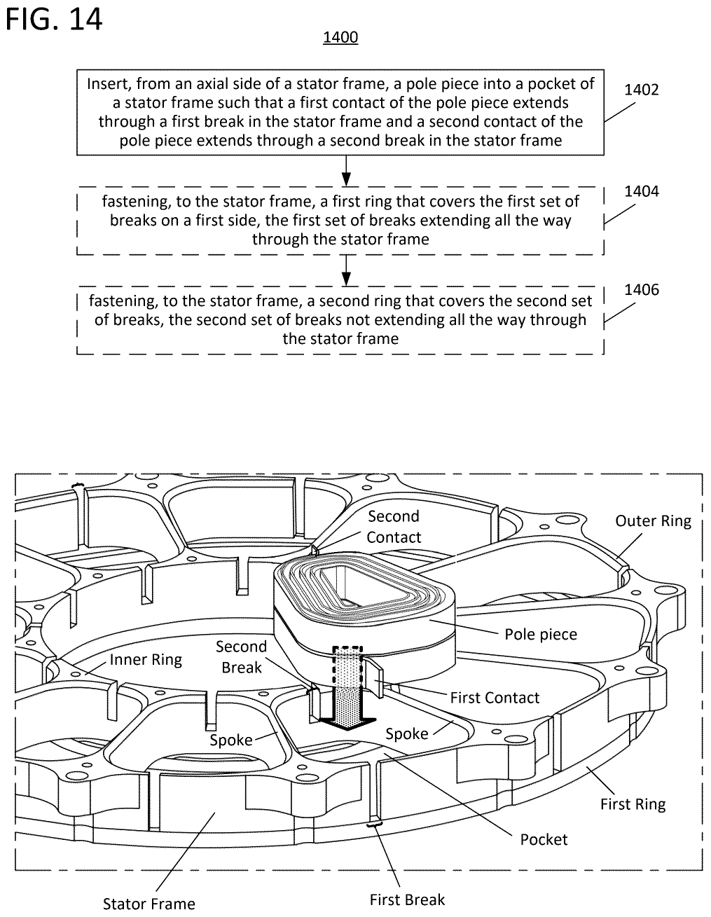

FIG. 14 illustrates an example of method 1400 of assembling a stator for an axial flux electric machine in accordance with specific embodiments of the inventions disclosed herein. Method 1400 may be implemented by a system including a stator frame, an inner ring of the stator frame, an outer ring of the stator frame, a set of pockets, a set of pole pieces, and a set of spokes. In specific embodiments, the system may also include a first set of breaks in the stator frame, a second set of breaks in the stator frame, a first ring, a second ring, mounting lobes, an electrically insulated adhesive, a set of air channels in the set of spokes, a first set of orifices, and a second set of orifices. Method 1400 may be implemented by a system including means for performing the steps of method 1400. Steps, or portions of steps, of method 1400 may be duplicated, omitted, rearranged, or otherwise deviate from the form shown. Additional steps may be added to method 1400. Steps, or portions of steps, of method 1400 may be performed in series or parallel.

At step 1402, a pole piece may be inserted into a pocket of a stator frame. The pole piece may be inserted from an axial side of the stator frame. The pole piece may be inserted into the pocket such that a first contact (e.g., coil tail) of the pole piece extends through a first break in the stator frame and a second contact of the pole piece extends through a second break in the stator frame. The stator frame may include an inner ring, an outer ring, and a set of spokes. The pocket may be part of a set of pockets. The set of spokes of the stator frame may connect the inner ring to the outer ring and may form the set of pockets. The first break may be part of a set of first breaks having the same cardinality as the set of pockets. The second break may be part of a second set of breaks having the same cardinality as the set of pockets.

In specific embodiments, the pole piece may comprise a composite coil formed of a ribbon of conductive material and a ribbon of soft magnetic material. In specific embodiments, the pole piece may be double sided with a first side that is opposite a second side in an axial direction of the axial flux electric machine. In specific embodiments, the composite coil may coil in from a first outer contact on the first side and may coil out to a second outer contact on the second side.

In specific embodiments, at step 1404, a first ring may be fastened to the stator frame. The first ring may cover the first set of breaks on a first side. The first set of breaks may extend all the way through the stator frame (e.g., the first set of breaks may be complete breaks). In specific embodiments, another (e.g., third) ring may cover the first set of breaks on a second side (e.g., opposite the first side).

In specific embodiments, at step 1406, a second ring may be fastened to the stator frame. The second ring may cover the second set of breaks. The second set of breaks may not extend all the way through the stator frame (e.g., the second set of breaks may be partial breaks).

Specific embodiments of the stator formed by method 1400 may include specific materials which can increase ease of manufacturing, improved electrical performance (e.g., reduced eddy currents), and increase ease of assembly. The pockets holding the pole pieces may be formed by spokes that improve the mechanical strength of the stator. In specific embodiments, air channels in the stator may improve thermal performance.

While the specification has been described in detail with respect to specific embodiments of the invention, it will be appreciated that those skilled in the art, upon attaining an understanding of the foregoing, may readily conceive of alterations to, variations of, and equivalents to these embodiments. For example, although examples in the disclosure were generally directed to motors, similar principles may be applied to generators. Furthermore, although stainless steel is used as an example material of a stator frame, other materials may be used. These and other modifications and variations to the present invention may be practiced by those skilled in the art, without departing from the scope of the present invention, which is more particularly set forth in the appended claims.

What is claimed is:

1. A stator for an axial electric machine comprising:
a stator frame;
an inner ring of the stator frame;
an outer ring of the stator frame;
a set of pockets;
a set of pole pieces occupying the set of pockets; and
a set of spokes of the stator frame, wherein the set of spokes of the stator frame connects the inner ring to the outer ring and forms the set of pockets;
wherein the stator frame is formed of a diamagnetic metal with a tensile strength greater than 200 MPa, a yield strength greater than 100 MPa, and an electric resistivity greater than 50×10⁻⁸ ohm-meters.

2. The stator of claim 1, wherein the stator frame is formed of a steel alloy with nickel and chromium.

3. The stator of claim 1, wherein the stator frame is formed of stainless steel.

4. The stator of claim 1, wherein:
the pole pieces in the set of pole pieces each comprise a composite coil formed of a ribbon of conductive material and a ribbon of soft magnetic material.

5. The stator of claim 4, wherein:
the inner ring has a first set of breaks that has the same cardinality as the set of pockets;
the outer ring has a second set of breaks that has the same cardinality as the set of pockets; and
at least one of the first set of breaks and the second set of breaks extends all the way through the stator frame.

6. The stator of claim 5, wherein:
one of the first set of breaks and the second set of breaks does not extend all the way through the stator frame.

7. The stator of claim 6, wherein:
the pole pieces in the set of pole pieces are double sided with a first side that is opposite a second side in an axial direction of the axial electric machine; and
each composite coil coils in from a first outer contact on the first side and coils out to a second outer contact on the second side.

8. The stator of claim 7, wherein:
the first outer contact of each composite coil is part of a set of first outer contacts;
the second outer contact of each composite coil is part of a set of second outer contacts;
the set of first outer contacts extends through the first set of breaks; and
the set of second outer contacts extends through the second set of breaks.

9. The stator of claim 4, wherein:
the outer ring has a first set of breaks that has the same cardinality as the set of pockets and a second set of breaks that has the same cardinality as the set of pockets; and
at least one of the first set of breaks and the second set of breaks extends all the way through the stator frame.

10. The stator of claim 5, further comprising:
a first ring that is fastened to the stator frame and covers the second set of breaks on a first side; and
a second ring that is fastened to the stator frame and covers the first set of breaks.

11. The stator of claim 10, wherein:
the first ring is segmented such that gaps between segments of the first ring are radially aligned with the set of spokes.

12. The stator of claim 11, further comprising:
a set of mounting lobes of the stator frame, the mounting lobes in the set of mounting lobes being radially aligned with the gaps between the segments of the first ring.

13. The stator of claim 4, further comprising:
an electrically insulative adhesive that isolates the composite coils and the stator frame.

14. The stator of claim 4, wherein the composite coils of the pole pieces are sheathed in an insulating material.

15. The stator of claim 10, further comprising:
an insulating material, wherein the insulating material isolates the first ring from the stator frame, the second ring from the stator frame, and the composite coils from the stator frame.

16. The stator of claim 1, wherein:
the stator frame is coated in an insulating material.

17. The stator of claim 1, further comprising:
a set of air channels in the set of spokes;
a first set of orifices of the set of air channels proximate the inner ring; and
a second set of orifices of the set of air channels proximate the outer ring.

18. A stator for an axial electric machine comprising:
a stator frame;
an inner ring of the stator frame;
an outer ring of the stator frame;
a set of pockets;
a set of pole pieces occupying the set of pockets;
a set of spokes of the stator frame, wherein the set of spokes of the stator frame connects the inner ring to the outer ring and forms the set of pockets;
a first set of breaks in the stator frame that has the same cardinality as the set of pockets; and
a second set of breaks in the stator frame that has the same cardinality as the set of pockets;
wherein at least one of the first set of breaks and the second set of breaks extends all the way through the stator frame.

19. The stator of claim 18, wherein one of the first set of breaks and the second set of breaks does not extend all the way through the stator frame.

20. The stator of claim 18, wherein the first set of breaks and the second set of breaks are formed in the outer ring.

21. The stator of claim 18, wherein:
the first set of breaks is formed in the inner ring; and
the second set of breaks is formed in the outer ring.

22. The stator of claim 18, wherein:
the pole pieces in the set of pole pieces each comprise a composite coil formed of a ribbon of conductive material and a ribbon of soft magnetic material;
the pole pieces in the set of pole pieces are double sided with a first side that is opposite a second side in an axial direction of the axial electric machine; and
each composite coil coils in from a first outer contact on the first side and coils out to a second outer contact on the second side.

23. The stator of claim 22, wherein:
the first outer contact of each composite coil is part of a set of first outer contacts;
the second outer contact of each composite coil is part of a set of second outer contacts;
the set of first outer contacts extends through the first set of breaks; and
the set of second outer contacts extends through the second set of breaks.

24. The stator of claim 18, further comprising:
a first ring that is fastened to the stator frame and covers the first set of breaks on a first side, the first set of breaks extending all the way through the stator frame; and
a second ring that is fastened to the stator frame and covers the second set of breaks, the second set of breaks not extending all the way through the stator frame.

25. A method of assembling a stator for an axial flux electric machine comprising:
inserting, from an axial side of a stator frame, a pole piece into a pocket of the stator frame such that a first contact of the pole piece extends through a first break in the stator frame and a second contact of the pole piece extends through a second break in the stator frame;
wherein: (i) the stator frame includes an inner ring, an outer ring, and a set of spokes; (ii) the pocket is part of a set of pockets; (iii) the set of spokes of the stator frame connects the inner ring to the outer ring and forms the set of pockets; (iv) the first break is part of a first set of breaks having the same cardinality as the set of pockets; and (v) the second break is part of a second set of breaks having the same cardinality as the set of pockets.

26. The method of claim 25, further comprising:
fastening, to the stator frame, a first ring that covers the first set of breaks on a first side, the first set of breaks extending all the way through the stator frame; and
fastening, to the stator frame, a second ring that covers the second set of breaks, the second set of breaks not extending all the way through the stator frame.

27. The method of claim 25, wherein:
the pole piece comprises a composite coil formed of a ribbon of conductive material and a ribbon of soft magnetic material;
the pole piece is double sided with a first side that is opposite a second side in an axial direction of the axial flux electric machine; and
the composite coil coils in from a first outer contact on the first side and coils out to a second outer contact on the second side.
